(19) United States
(12) Patent Application Publication
(10) Pub. No.: US 2026/0128511 A1
(43) Pub. Date: May 7, 2026

(54) METHOD OF PERFORMING BEAMFORMING AND AN APPARATUS THEREOF

(71) Applicant: AGENCY FOR DEFENSE DEVELOPMENT, Daejeon (KR)

(72) Inventors: Jae Hyuk LIM, Daejeon (KR); Sun Jin OH, Daejeon (KR); Eui Hyuk LEE, Daejeon (KR); Sung Kweon KIM, Daejeon (KR); Dae Kyo JEONG, Daejeon (KR)

(21) Appl. No.: 18/987,289

(22) Filed: Dec. 19, 2024

(30) Foreign Application Priority Data
Nov. 5, 2024 (KR) 10-2024-0155303

(51) Int. Cl. H01Q 3/26

(52) U.S. Cl. CPC H01Q 3/26

(57) ABSTRACT

Systems, devices, methods, and instructions for performing beamforming on a signal by an electronic apparatus are provided, including training a deep neural network associated with beamforming on a signal, identifying an input signal input through an antenna array element, obtaining an autocorrelation matrix corresponding to the input signal, obtaining a weight vector from the autocorrelation matrix based on the deep neural network, and obtaining an output signal of the antenna array element corresponding to the input signal based on the weight vector.

### PRIORITY INFORMATION

This application claims the benefit of Korean Patent Application No. 10-2024-0155303, filed on Nov. 5, 2024 in the Korean Intellectual Property Office, the disclosure of which is incorporated herein by reference in its entirety.

### FIELD OF THE DISCLOSURE

The present disclosure relates to systems, devices, methods, and instructions for performing beamforming. An example implementation relates to a method of performing beamforming in a large array while minimizing degradation of signal-to-inference-plus-noise ratio (SINR) performance based on a null-space beamforming method by an electronic apparatus and an apparatus thereof.

### DISCUSSION OF THE RELATED ART

Beamforming methods have attempted to directly calculate the weights of antenna array elements based on the minimum variance distortion-less response (MVDR) method without separate processing. However, the problem with the MVDR method is that the signal-to-interference noise ratio (SINR) performance deteriorates as the number of array elements increases.

In order to apply the blind beamforming method using a deep neural network in a defense industry system that requires a large number of array elements in the antenna, it is necessary to improve the SINR performance degradation problem that occurs as the number of array elements increases. Therefore, the present disclosure proposes a beamforming method that minimizes the SINR performance degradation in large array elements based on a null-space beamforming method

### SUMMARY

An aspect provides an electronic apparatus capable of performing beamforming in a large array with minimum degradation of signal-to-inference-plus-noise ratio (SINR) performance based on a null-space beamforming method.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings

According to an aspect, there is provided a method of performing beamforming on a signal by an electronic apparatus, the method including training a deep neural network associated with beamforming on a signal, identifying an input signal input through an antenna array element, obtaining an autocorrelation matrix corresponding to the input signal, obtaining a weight vector from the autocorrelation matrix based on the deep neural network, and obtaining an output signal of the antenna array element corresponding to the input signal based on the weight vector.

In the method of performing beamforming by an electronic apparatus according to an example embodiment, training the deep neural network may include modeling a training input signal, obtaining a training autocorrelation matrix corresponding to the training input signal, obtaining an input data vector based on the training autocorrelation matrix, and training the deep neural network to output an output data vector comprising a training output weight in response to an input of the input data vector, and the training of the deep neural network may include feedback according to a loss function defined based on an optimal array element weight vector for a null-space beamforming method and the output data vector.

In the method of performing beamforming by an electronic apparatus according to an example embodiment, the deep neural network may include an input layer for receiving input data, an output layer for outputting output data, and at least one hidden layer located between the input layer and the output layer, and each hidden layer included in the at least one hidden layer may include a fully connected layer, and a rectified linear unit (ReLU) layer.

In the method of performing beamforming by an electronic apparatus according to an example embodiment, modeling the training input signal may include modeling the training input signal based on a uniform linear array comprising isotropic elements.

In the method of performing beamforming by an electronic apparatus according to an example embodiment, the optimal array element weight for the null-space beamforming method may be calculated based on an interference signal space comprising a plurality of steering vectors.

In the method of performing beamforming by an electronic apparatus according to an example embodiment, obtaining the input data vector may include obtaining an upper triangular matrix element vector based on the training autocorrelation matrix, obtaining a training element vector corresponding to the training autocorrelation matrix based on real and imaginary parts extracted from the upper triangular matrix element vector, and normalizing the training element vector to obtain the input data vector.

In the method of performing beamforming by an electronic apparatus according to an example embodiment, the output data vector may be obtained based on real and imaginary parts extracted from the training output weight, and the optimal array element weight vector may be obtained based on real and imaginary parts extracted from the optimal array element weight for the null-space beamforming method.

In the method of performing beamforming by an electronic apparatus according to an example embodiment, training the deep neural network may include training the deep neural network to minimize an operational value of the loss function based on a plurality of input data vectors set for the training of the deep neural network including the input data vector and a plurality of output data vectors set for the training of the deep neural network including the output data vector.

According to another aspect, there is provided a non-transitory computer-readable storage medium having a program for executing on a computer a method of performing beamforming by an electronic apparatus recorded thereon, the method including training a deep neural network associated with beamforming on a signal, identifying an input signal input through an antenna array element, obtaining an autocorrelation matrix corresponding to the input signal, obtaining a weight vector from the autocorrelation matrix based on the deep neural network, and obtaining an output signal of the antenna array element corresponding to the input signal based on the weight vector.

According to yet another aspect, there is provided an electronic apparatus for performing beamforming on a signal, the electronic apparatus including a processor, and one or more memory for storing one or more instructions. The one or more instructions, when executed, causes the processor to train a deep neural network associated with beamforming on a signal, identify an input signal input through an antenna array element, obtain an autocorrelation matrix corresponding to the input signal, obtain a weight vector from the autocorrelation matrix based on the deep neural network, and obtain an output signal of the antenna array element corresponding to the input signal based on the weight vector.

The various example embodiments of the present disclosure described above are only some of the example embodiments of the present disclosure, and various other example embodiments reflecting the technical features of the various example embodiments of the present disclosure can be derived and understood by those skilled in the art based on the detailed description set forth below.

The technical effect of this disclosure is to maintain consistent antenna performance as the number of array elements increases without degradation in signal-to-interference noise ratio (SINR) performance.

The effects of the present disclosure are not limited to the effects mentioned above, and other effects not mentioned will be clearly understood by those skilled in the art from the following description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating an electronic apparatus according to an example embodiment.

FIG. 2 is a diagram illustrating a modeling process of a training input signal according to an example embodiment.

FIG. 3 is a diagram illustrating a training process of a deep neural network associated with beamforming on a signal, according to an example embodiment.

FIG. 4 is a diagram illustrating a signal-to-interference noise ratio (SINR) result relative to a signal-to-noise ratio (SNR) obtained according to a conventional adaptive beamforming method.

FIG. 5 is a diagram illustrating a SINR result according to a SNR obtained according to a beamforming method of the present disclosure.

FIG. 6 is a diagram illustrating gain patterns of antennas obtained according to a conventional adaptive beamforming method.

FIG. 7 is a diagram illustrating gain patterns of antennas obtained according to a beamforming method of the present disclosure.

FIG. 8 is a flowchart of how an electronic apparatus performs beamforming according to a representative example embodiment

### DETAILED DESCRIPTION

Reference will now be made in detail to the embodiments of the present invention, examples of which are illustrated in the accompanying drawings.

The following example embodiments are combinations of components and features of various example embodiments in predetermined forms. Each component or feature may be considered as optional unless explicitly stated otherwise. Each component or feature may be implemented in a form that is not combined with other components or features. In addition, various example embodiments may be configured by combining some components and features. The order of operations described in various example embodiments may be changed. Some configurations or features of one example embodiment may be included in other example embodiments, or may be replaced with corresponding configurations or features of other example embodiments.

In describing the drawings, descriptions of procedures or operations that may obscure the gist of various example embodiments are not described, and procedures or operations that are understandable at the level of those skilled in the art are not described either.

Throughout the specification, when it is stated that a part “comprises” or “includes” a certain component, it means that other components may further be included, and it does not preclude other components, unless otherwise stated. In addition, terms such as “ . . . part”, “ . . . unit”, “ . . . module”, and the like described in the specification mean a unit for performing at least one function or operation, which may be implemented as hardware or software, or as a combination of hardware and software. In addition, “a”, “an”, “one”, “the” and similar related terms are used herein in a sense encompassing both the singular and the plural in the context of describing various example embodiments (especially in the context of the following claims) unless otherwise indicated or clearly contradicted by context.

Hereinafter, preferred implementations according to various example embodiments will be described in detail with reference to the accompanying drawings. The detailed description to be disclosed below with the accompanying drawings is intended to describe exemplary implementations of various example embodiments, and is not intended to represent the only implementation.

In addition, specific terms used in various example embodiments are provided to aid understanding of various example embodiments, and the use of these specific terms may be changed in other forms without departing from the technical spirit of the various example embodiments.

In telecommunications, smart antenna systems utilizing adaptive signal processing and artificial intelligence technologies are implemented to improve communication quality and efficiently utilize frequency resources. These technologies are key elements required for next-generation communication technologies such as κG. One of the technologies used in smart antenna systems is the adaptive beamforming method, in which the main lobe can be steered to transmit/receive signals at a specific angle, and at other angles, it can create as much null-space as possible to improve the signal-to-interference noise ratio (SINR). Examples of adaptive beamforming methods include the minimum variance distortion-less response (MVDR) method and null-space beamforming.

The MVDR method has the advantage of keeping the SINR undistorted, but may have the disadvantage of high sidelobe levels, which can degrade overall performance. The MVDR method is also known as the blind beamforming method due to its ability to suppress interfering signals based on the autocorrelation matrix without knowing the location of the interfering signals.

Adaptive beamforming methods need to iteratively calculate weights and adapt to dynamic environments. Therefore, to cope with the practical limitations of adaptive beamforming methods, artificial intelligence techniques with the ability to learn and predict patterns in large data environments can be proposed as a solution. In particular, the blind beamforming method can directly calculate the weights of antenna array elements without any additional processing. In recent years, studies have been conducted to introduce artificial intelligence to solve the computational challenges of the blind beamforming method, but most studies have been limited to around 10 antenna array elements. This is because as the number of array elements increases, the weight dimension with nonlinearity increases, making it difficult to learn the weights, which can lead to degraded SINR performance.

Therefore, the present disclosure proposes a beamforming method that minimizes SINR performance degradation in a large array element based on a null-space beamforming method.

In particular, the beamforming method of the present disclosure can be effectively applied to the defense field, where communication is performed using a communication device having a large number of antenna array elements. As an example, in a communication system in the defense field, precise signal transmission/reception, high resolution and interference rejection capability may be required, and to support this, it is necessary to predict signal weights in the array elements more accurately for signals transmitted and received through a device having many antenna array elements. In response to these characteristics of the defense field, the beamforming method presented herein below can be understood as a technical idea that can be easily applied to communication systems for various military units by managing to predict signal weights in the array elements more accurately to maintain SINR performance even when the number of array elements increases through deep neural network learning based on a null-space beamforming method.

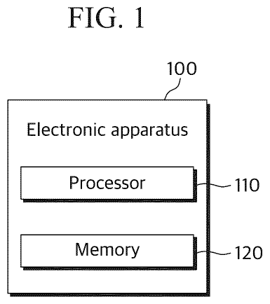

FIG. 1 is a diagram illustrating an electronic apparatus according to an example embodiment

Referring to FIG. 1, the electronic apparatus 100 may include a processor 110 and a memory 120. The electronic apparatus 100 illustrated in FIG. 1 shows only the components associated with the present example embodiment. Accordingly, it will be understood by those skilled in the art related to the present example embodiment that other general purpose components may be included in addition to the components illustrated in FIG. 1. For example, the electronic apparatus 100 may include a communication device including one or more transceivers, an input unit, and an output unit. The communication device is a device for performing wired or wireless communication and may communicate with an external electronic apparatus. The external electronic apparatus may be a terminal or a server. The communication technologies utilized by the communication device may include Global System for Mobile communication (GSM), Code Division Multi Access (CDMA), Long Term Evolution (LTE), 5G, Wireless LAN (WLAN), Wireless-Fidelity (Wi-Fi), Bluetooth, Radio Frequency Identification (RFID), Infrared Data Association (IrDA), ZigBee, Near Field Communication (NFC), and the like. The input unit may be, for example, a traditional keypad or keyboard, a mouse, a microphone for receiving voice signals, a camera, and various other forms of input means for sensing or receiving user input. The output unit may be, for example, a display that outputs images, a speaker that outputs sound, a haptic device that generates vibrations, and various other forms of output means.

The electronic apparatus 100 of FIG. 1 may train a deep neural network associated with beamforming on the signal. The electronic apparatus 100 may identify an input signal input via an antenna array element. The electronic apparatus 100 may then obtain an autocorrelation matrix corresponding to the input signal. The electronic apparatus 100 may obtain a weight vector from the obtained autocorrelation matrix based on the deep neural network. Based on the obtained weight vector, the electronic apparatus 100 may obtain an output signal of the antenna array element corresponding to the input signal.

The processor 110 serves to control the overall functionality of the electronic apparatus 100. For example, the processor 110 provides overall control of the electronic apparatus 100 by executing programs stored in the memory 120 within the electronic apparatus 100. The processor 110 may be implemented as a central processing unit (CPU), graphics processing unit (GPU), application processor (AP), or the like within the electronic apparatus 100, but is not limited thereto.

The memory 120 is hardware that stores various data processed within the electronic apparatus 100, and the memory 120 may store data that has been processed and data to be processed by the electronic apparatus 100. The memory 120 may also store applications, drivers, and the like to be executed by the electronic apparatus 100. The memory 120 may include random access memory (RAM), such as dynamic random access memory (DRAM), static random access memory (SRAM), or the like, read-only memory (ROM), electrically erasable programmable read-only memory (EEPROM), CD-ROM, Blu-ray or other optical disk storage, hard disk drive (HDD), solid state drive (SSD), or flash memory.

The disclosed method of performing beamforming performed by the electronic apparatus 100 of FIG. 1 may also be implemented by a non-transitory storage medium (or non-transitory recording medium) readable by a computer for its operation. The method of performing beamforming may be implemented as a software module or algorithm and stored on a computer-readable recording medium as computer-readable code or program instructions executable on the processor 110. Computer-readable recording media include magnetic storage media (e.g., read-only memory (ROM), random-access memory (RAM), floppy disks, hard disks, etc.) and optical readable media (e.g., CD-ROMs, digital versatile discs (DVDs)). The computer-readable recording medium may be distributed across networked computer systems so that computer-readable code may be stored and executed in a distributed manner. The medium may be readable by a computer, stored in memory, and executed by the processor 110.

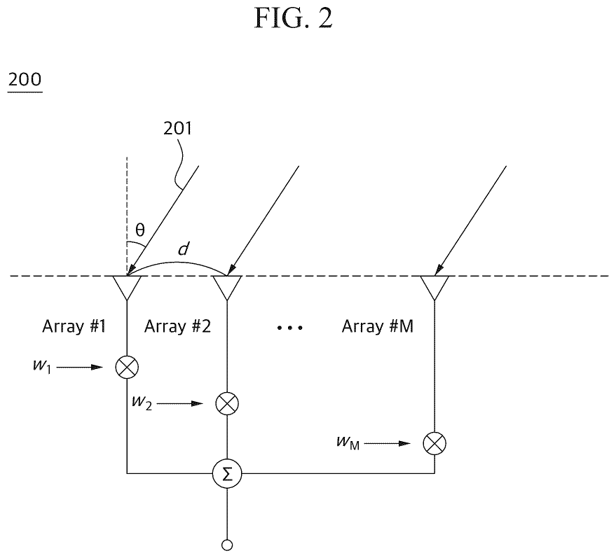

FIG. 2 is a diagram illustrating a modeling process of a training input signal according to an example embodiment.

Referring to FIG. 2, the electronic apparatus 100 may model a training input signal to train a deep neural network. The electronic apparatus 100 may assume a uniform linear array (ULA) 200 including M isotropic elements with an inter-element spacing d to model the training input signal. Here, the inter-element spacing d=λ/2.

The steering vector \vec{aₛ}(θ) 201 for the incident angle θ can be defined as in Equation 1.

$$\vec{{a}_{s}} ( θ ) = {[ exp ( - j {β}_{0} ( θ ) ) , … , , exp ( - j {β}_{M - 1} ( θ ) ]}^{T} \qquad [ Equation 1 ]$$

where, βₙ(θ) of Equation 1 can be expressed by Equation 2.

$${β}_{n} ( θ ) = \frac{2 π}{λ} nd sin ( θ ) \qquad [ Equation 2 ]$$

Among the multiple signals entering the uniform linear array 200, the incident angle for the signal to be steered can be defined as θ_{d}, and the incident angle for the N interfering signals can be defined as θᵢ, where i=1, 2, . . . , N. In this case, the input signal \vec{x}[k] entering the uniform linear array 200 can be modeled as in Equation 3.

$$\vec{x} [ k ] = {s}_{d} [ k ] \vec{{a}_{s}} ( {θ}_{d} ) + {\sum }_{i = 1}^{N} {s}_{i} [ k ] \vec{{a}_{5}} ( {θ}_{i} ) + \vec{n} [ k ] \qquad [ Equation 3 ]$$

Equation 3 can also be expressed in the form of \vec{x}[k]=[x₀[k], . . . , x_{M-1}[k]]. In Equation 3, S_{d} and Sᵢ correspond to the steering signal and interfering signal, Sd and respectively, and respective signals may not be correlated. In addition, the noise \vec{n}[k] can be assumed to be Gaussian noise satisfying the independent and identically distributed (i.i.d.) condition.

The input signals represented by Equations 1 to 3 may be combined into a single signal at the output of the antenna array element, and this array element output signal may be represented by Equation 4.

$$\vec{y} [ k ] = {\sum }_{m = 1}^{M} {w}_{m} {x}_{m} [ k ] = {\vec{w}}^{H} \vec{x} [ k ] \qquad [ Equation 4 ]$$

Here, the array element weight vector \vec{ω} is expressed as in Equation 5.

$$\vec{w} = [ {w}_{0} , … , {w}_{M - 1} ] \qquad [ Equation 5 ]$$

The electronic apparatus 100 may obtain an autocorrelation matrix Rₛ via Equation 6, from the input signal \vec{x}[k]. That is, the autocorrelation matrix may correspond to the result of averaging the matrix generated by multiplying the input signals and the Hermitian Transpose of the input signals. The electronic apparatus 100 may estimate the incoming signal at a particular angle from the autocorrelation matrix information.

$${R}_{S} = E [ \vec{x} [ k ] {\vec{w}}^{H} [ k ] ] \qquad [ Equation 6 ]$$

Conventional MVDR method may require signal information other than the steering signal to calculate the weights of the array elements to minimize the variance of the received signals. Compared to the null-space beamforming method, the signal \vec{x}[k] consisting only of noise and interference signals can be expressed as in Equation 7.

$$\tilde{x} [ k ] = {\sum }_{i = 1}^{N} {s}_{i} [ k ] \text{?} ( {θ}_{i} ) + \vec{n} [ k ] \qquad [ Equation 7 ]$$

$$\text{?} \text{indicates text missing or illegible when filed}$$

From Equation 7, another autocorrelation matrix Cₛ can be obtained, which can be expressed as in Equation 8.

$${C}_{s} = E [ \tilde{x} [ k ] {\tilde{x}}^{H} [ k ] ] \qquad [ Equation 8 ]$$

Instead of the conventional MVDR method based on Equations 7 and 8, the present disclosure utilizes a null-space beamforming method based on Equations 3 to 6, which is less complex and computationally less intensive. The optimal array element weight vector \vec{ω}ₒₚₜ for the null-space beamforming method can be expressed as in Equation 9.

$${\vec{w}}_{opt} = δ {\vec{A} ( {\vec{A}}^{H} \vec{A} )}^{- 1} \vec{g} \qquad [ Equation 9 ]$$

where \vec{A}=[\vec{aₛ}(θ_{d})\vec{aₛ}(θ₁) . . . \vec{aₛ}(θ_{N})], \vec{g}=[10 . . . 0]^{T} and δ corresponds to the array element weight normalization constant. As can be seen from Equation 9, the optimal array element weight for the null-space beamforming method can be calculated based on the interference signal space \vec{A} including a plurality of steering vectors 201 and the Hermitian transpose of \vec{A}.

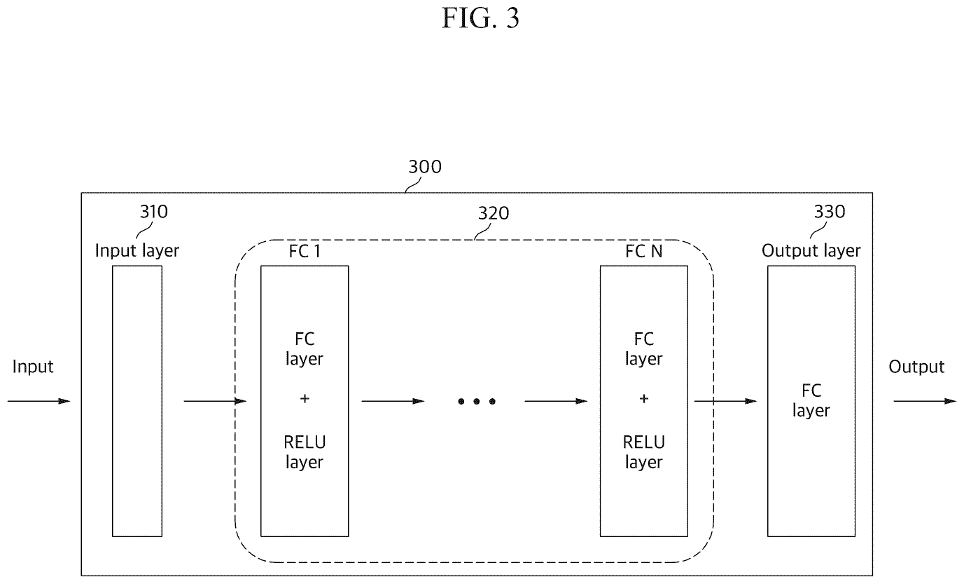

FIG. 3 is a diagram illustrating a training process of a deep neural network associated with beamforming on a signal, according to an example embodiment.

Referring to FIG. 3, the electronic apparatus 100 may train a deep neural network 300 that outputs an array element weight for estimating an output signal according to Equation 4 by taking an autocorrelation matrix Rₛ of an input signal according to Equation 6 as input. In other words, the deep neural network 300 of FIG. 3 may correspond to a neural network for training to output data of weights for estimating the output signal of the array element corresponding to the input signal by taking data of the autocorrelation matrix of the input signal of the array element as input. The deep neural network 300 may include a fully connected layer (FC layer) that is efficient in terms of computation speed and computation volume. Referring to FIG. 3, the deep neural network 300 may include an input layer 310 that receives input data, at least one hidden layer 320 that is located between the input layer and an output layer and includes features between the input and output, and the output layer 330 that exports output data, in which each hidden layer included in the at least one hidden layer 320 may include a single fully connected layer and an activation function rectified linear unit (ReLU) layer. The activation function ReLU is defined as in Equation 10.

$$σ ( x ) = ReLU ( x ) = \{ \begin{matrix}x , x \geq 0 \\ 0 else\end{matrix} \qquad [ Equation 10 ]$$

The electronic apparatus 100 may obtain an input data vector \vec{z} based on the autocorrelation matrix Rₛ. The electronic apparatus 100 may first obtain an element vector \tilde{r} based on the values of the elements of the upper triangular matrix of Rₛ, as in Equation 11, where the magnitude of the element vector \tilde{r} is N×(N+1)/2 Here, the upper triangular matrix means a matrix in which only the elements above the diagonal have non-zero values, and the elements below the diagonal of the matrix are all zero.

$$\tilde{r} = {[ {R}_{11} , {R}_{12} , … , {R}_{1 M} , {R}_{22} , … , {R}_{2 M} , … , {R}_{MM} ]}^{T} \qquad [ Equation 11 ]$$

The element vector \tilde{r} of the upper triangular matrix may contain complex numbers. Therefore, to be used as training input data, the real and imaginary parts must be separated, and the electronic apparatus 100 may extract the real and imaginary parts of \tilde{r} to obtain a new element vector \hat{r}. The new element vector \hat{r} may be represented as in Equation 12, where the size of the new element vector \hat{r} is N×(N+1).

$$\hat{r} = {[ real ( \tilde{r} ) , imag ( \tilde{r} ) ]}^{T} \qquad [ Equation 12 ]$$

The electronic apparatus 100 may then normalize the new element vector \hat{r} to obtain the input data vector \vec{z} to be input to the deep neural network 300, as in Equation 13. In this case, the size of the input data vector \vec{z} is the same as the vector size of the new element vector \hat{r}, which is N×(N+1)

$$\vec{z} = \frac{\hat{r}}{‖ \hat{r} ‖} \qquad [ Equation 13 ]$$

When the input data vector \vec{z} obtained according to Equations 11 to 13 based on the training autocorrelation matrix corresponding to the input signal configured for training is input to the deep neural network 300, an output data vector including a weight vector predicted for the input signal may be output from the deep neural network 300, in which the weight vector predicted for the input signal may also be understood to correspond to a training weight vector in that the input signal is for training.

The electronic apparatus 100 may utilize the optimal weight of the null-space beamforming method obtained via Equation 9 for the output data vector of the deep neural network 300. Since the optimal weight of the null-space beamforming method is also in the form of complex number, the electronic apparatus 100 may construct the output data vector by extracting the real and imaginary part separately. The output data vector W constructed accordingly can be represented as in Equation 14, where the size of the output data vector is 2N.

$$\hat{w} = {[ real ( \vec{w} ) , imag ( \vec{w} ) ]}^{T} \qquad [ Equation 14 ]$$

In Equation 14, \vec{ω} may be the optimal weight vector \vec{ω}ₒₚₜ obtained through Equation 9 or may be the predicted weight vector \vec{ω}_{Predid} included in the output data vector output by the deep neural network 300. The dataset at input and output includes the input data vector and the output data vector, which may be represented as (\vec{z}^{γ}; \hat{ω}^{γ}), γ=1, 2, . . . . D, where D is the number of dataset samples set for fine-tuning the model. Based on these D data sets, the electronic apparatus 100 can train the deep neural network 300 such that the operational value of the obtained loss function L_{MSE} is minimized based on the optimal weight vector \vec{ω}ₒₚₜ and the predicted weight vector \vec{ω}_{Predid}. The loss function L_{MSE} is based on a deep mean square error method and may be expressed as in Equation 15.

$${L}_{MSE} = \frac{1}{D} \text{?} {( \text{?} - \text{?} )}^{2} \qquad [ Equation 15 ]$$

$$\text{?} \text{indicates text missing or illegible when filed}$$

In Equation 15, \hat{ω}ₒₚₜ may be the output data vector obtained based on \hat{ω}ₒₚₜ and Equation 14, and \hat{ω}_{predict} may be the output data vector obtained based on \vec{ω}_{Predid} and Equation 14. Equation 15 may mean that the training of the deep neural network 300 is performed according to the feedback of a loss function defined based on the optimal array element weight vector for the null-space beamforming method and the predicted weight vector included in the output data vector. When the electronic apparatus 100 trains the deep neural network 300, it may use the Adam [4] method to reduce the learning loss between trainings, and may apply an initial learning rate of 0.001 and an epoch of 3.

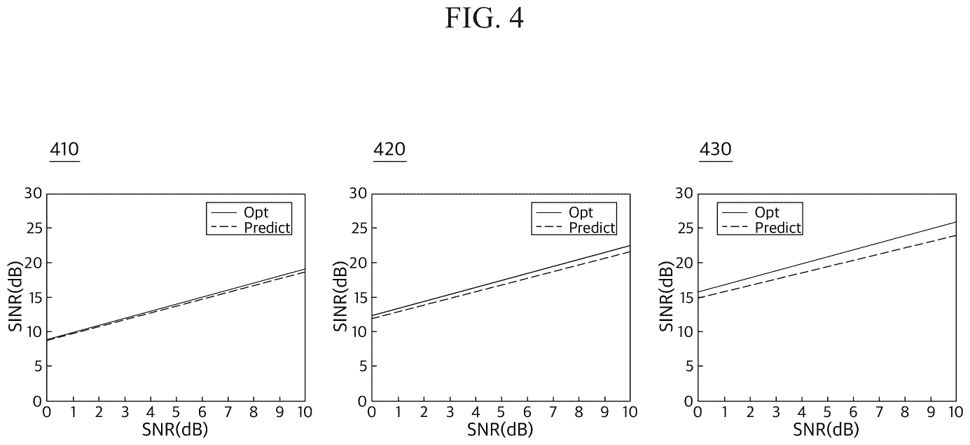

FIG. 4 is a diagram illustrating a signal-to-interference noise ratio (SINR) result relative to a signal-to-noise ratio (SNR) obtained according to a conventional adaptive beamforming method.

In the example of FIG. 4, in the process of configuring the antenna training scenario, the steering angle of the desired signal can be fixed at 0 degrees, and the range of the incident angle of the first interfering signal can be set between −40° and −20° in 1° intervals. In addition, the range of the incidence angle of the second interfering signal can be set to between 20° and 40° in 1° intervals. By limiting the range of incidence angles of the interfering signals and the desired signal in this way, 441 scenarios and 1,000,000 data sample sets can be generated, which can be used to train a deep neural network. At the array element level, the interference-to-signal ratio (ISR) can be assumed to be 10 dB and the SNR to be 5 dB.

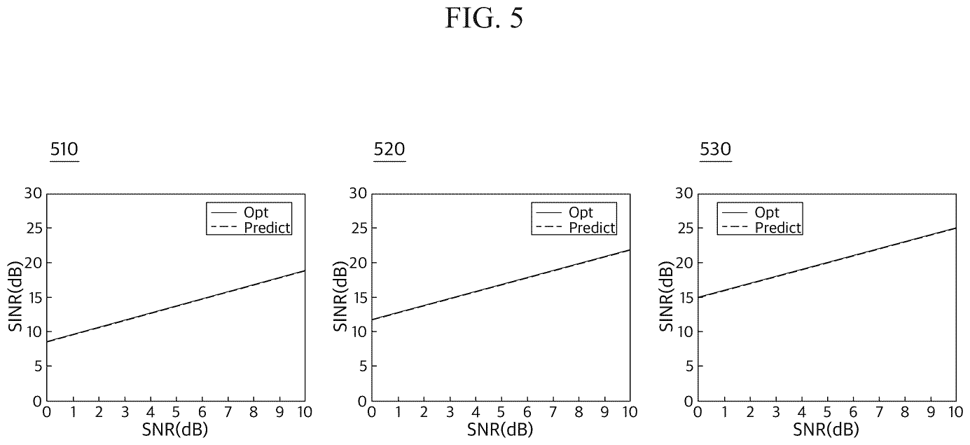

In conventional adaptive beamforming methods, learning becomes difficult as the number of array elements increases, resulting in degraded SINR performance. In FIG. 4 and later in FIG. 5, the performances of the conventional adaptive beamforming method and the beamforming method based on the deep neural network 300 of the present disclosure can be compared for the cases of 8, 16, and 32 array elements, respectively, to compare the effectiveness of the present disclosure with that of the conventional method. The respective deep neural networks of 410 to 430 of FIGS. 4 and 510 to 530 of FIG. 5, which will be described later, may be referred to as type 1 (8 array elements), type 2 (16 array elements), and type 3 (32 array elements). Accordingly, the sizes of the input data vectors \vec{z} of the deep neural networks of types 1 to 3 may be 72, 272, and 1056, respectively, and the sizes of the weight vectors W may be 16, 32, and 64, respectively.

The deep neural network can be configured based on three hyperparameters, including 1) batch size, 2) number of hidden layer nodes, and 3) number of hidden layers, and the optimal deep neural network can be designed by changing the hyperparameters. For example, optimal deep neural network hyperparameter values for types 1 to 3 are batch size of 128, number of hidden layer nodes of 128, and number of hidden layers of 2.

In performing training of the deep neural network, the electronic apparatus 100 utilizes weights obtained based on a null-space beamforming method (FIG. 5) instead of weights obtained based on a conventional MVDR method (FIG. 4).

First, FIG. 4 shows the SINR results obtained by constructing a neural learning network trained with the MVDR method, a conventional adaptive beamforming method, as the array element weight vector. The optimal array element weight \vec{ω}ₒₚₜ obtained by the conventional MVDR method can be expressed as in Equation 16.

$${\vec{w}}_{opt} = δ \text{?} {\vec{a}}_{s} ( {θ}_{d} ) \qquad [ Equation 16 ]$$

$$\text{?} \text{indicates text missing or illegible when filed}$$

Graphs 410 to 430 in FIG. 4 show the SINR results for type 1, type 2, and type 3 deep neural networks obtained based on a conventional adaptive beamforming method. In the antenna training scenario, the results can be obtained by generating 10,000 test data for each SNR for the SINR value, performing a Monte Carlo simulation, and then using the average value to obtain the results, and the SINR can be calculated by the process according to the following Equations 17 and 18.

In the input signal of Equation 3, the steering signal corresponds to \vec{x_{d}}[k]=s_{d}[k]\vec{aₛ}(θ_{d}), and the autocorrelation matrix Γₛ generated based on the steering signal can be expressed as in Equation 17.

$${Γ}_{s} = E [ \vec{{x}_{d}} [ k [ \vec{{x}_{d}} {}^{H} [ k ] ] \qquad [ Equation 17 ]$$

Here, the SINR obtained based on the autocorrelation matrix Cₛ obtained through Equation 8 and the array element weight vector \vec{ω} can be expressed as in Equation 18.

$$SIN R = \frac{\vec{{w}^{H}} {Γ}_{s} \vec{w}}{\vec{{w}^{H}} {C}_{s} \vec{w}} \qquad [ Equation 18 ]$$

The graph 410 shows the SINR values obtained based on \vec{ω}ₒₚₜ and \vec{ω}_{predict} obtained using a type 1 deep neural network. When the SNR is 5 dB, the SINR values obtained based on \vec{ω}ₒₚₜ and \vec{ω}_{predict} are 14.02 dB and 13.14 dB, respectively, revealing a difference of 0.21 dB. Furthermore, when the SINR average is calculated over the entire SNR range, it reveals a SINR difference of 0.23 dB. The graph 420 shows the SINR values obtained based on \vec{ω}ₒₚₜ and \vec{ω}_{predict} obtained using a type 2 deep neural network. When the SNR is 5 dB, the SINR values obtained based on \vec{ω}ₒₚₜ and \vec{ω}_{predict} are 17.37 dB and 16.84 dB, respectively, revealing a difference of 0.53 dB. An average SINR difference of 0.57 dB can be observed over the SNR range. The graph 430 shows the SINR values obtained based on \vec{ω}ₒₚₜ and \vec{ω}_{predict} obtained using a type 3 deep neural network, which shows the SINR values obtained based on \vec{ω}ₒₚₜ and \vec{ω}_{predict} of 20.80 dB and 19.63 dB, respectively, when the SNR is 5 dB, revealing a difference of 1.17 dB. In addition, an average SINR difference of 1.27 dB can be observed in the SNR range. In other words, according to the conventional adaptive beamforming method, the SINR performance deteriorates as the number of array elements increases.

The reason why the SINR value increases as the number of array elements increases is that a large amount of signals are combined as the number of array elements increases.

FIG. 5 is a diagram illustrating a SINR result according to a SNR obtained according to a beamforming method of the present disclosure.

FIG. 5 illustrates the SINR performance results according to the SNR for type 1, type 2, and type 3 deep neural networks obtained based on a method of performing beamforming of the present disclosure. The graph 510 shows the SINR values obtained based on \vec{ω}ₒₚₜ and \vec{ω}_{predict} obtained using a type 1 deep neural network. When the SNR is 5 dB, the SINR values obtained based on \vec{ω}ₒₚₜ and \vec{ω}_{predict} are 13.86 dB and 13.85 dB, respectively, revealing a difference of 0.01 dB. Furthermore, when the SINR average is calculated over the entire SNR range, it reveals a SINR difference of 0.01 dB. The graph 520 shows the SINR values obtained based on \vec{ω}ₒₚₜ and \vec{ω}_{predict} obtained using a type 2 deep neural network. When the SNR is 5 dB, the SINR values obtained based on \vec{ω}ₒₚₜ and \vec{ω}_{predict} are 17.03 dB and 17.02 dB, respectively, revealing a difference of 0.01 dB. An average SINR difference of 0.02 dB can be observed over the SNR range. The graph 530 shows the SINR values obtained based on \vec{ω}ₒₚₜ and \vec{ω}_{predict} obtained using a type 3 deep neural network, which shows the SINR values obtained based on \vec{ω}ₒₚₜ and \vec{ω}_{predict} of 20.07 dB and 20.05 dB, respectively, when the SNR is 5 dB, revealing a difference of 0.02 dB, with an average SINR difference of 0.02 dB over the SNR range.

In FIG. 5, it can be seen that there is no significant difference in the SINR values obtained based on \vec{ω}ₒₚₜ and \vec{ω}_{predict} obtained using a deep neural network according to the beamforming method of the present disclosure. Thus, the beamforming method of the present disclosure maintains consistent performance without degradation in SINR performance as the number of array elements increases.

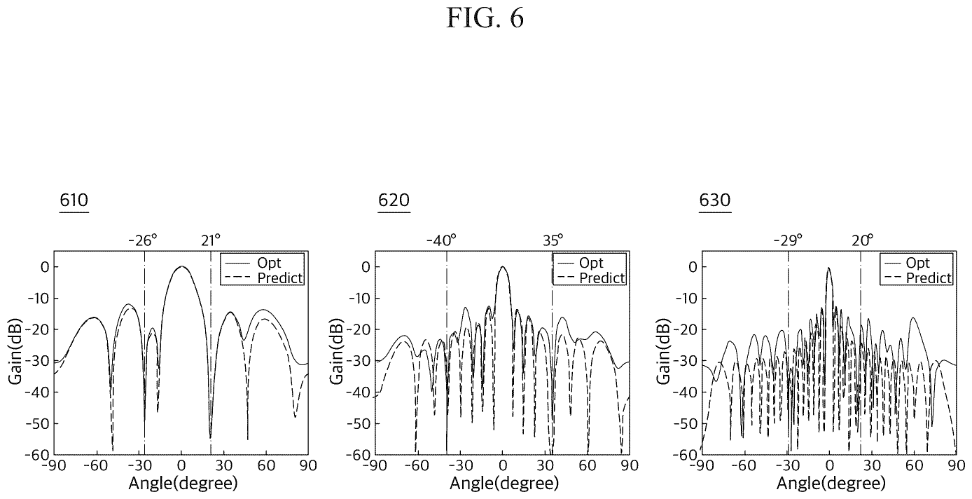

FIG. 6 is a diagram illustrating gain patterns of antennas obtained according to a conventional adaptive beamforming method.

Referring to FIG. 6, graphs 610, 620, and 630 show the antenna gain patterns obtained through the optimal weight vectors \vec{ω}ₒₚₜ of the conventional adaptive beamforming method and the weights \vec{ω}_{predict} obtained using the trained deep neural networks, for deep neural networks of type 1, type 2, and type 3, respectively. It can be seen that the difference between the gain pattern obtained using the optimal weight vector \vec{ω}ₒₚₜ of the conventional adaptive beamforming method and the gain pattern obtained using \vec{ω}_{predict} increases as the number of array elements increases, and this difference in gain patterns indicates that the conventional adaptive beamforming method results in a difference in the SINR performance.

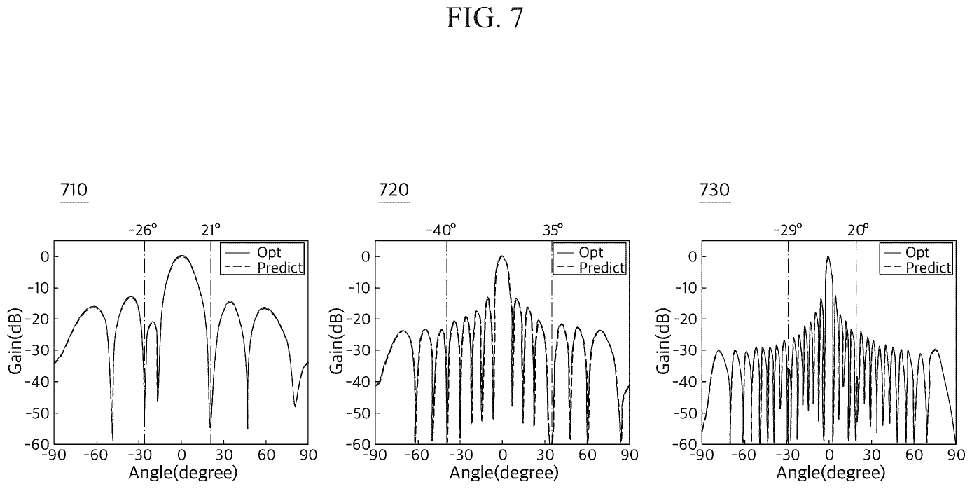

FIG. 7 is a diagram illustrating gain patterns of antennas obtained according to a beamforming method of the present disclosure.

Referring to FIG. 7, graphs 710, 720, and 730 show the antenna gain patterns obtained based on the optimal weight vectors \vec{ω}ₒₚₜ of the null-space beamforming method and the weights \vec{ω}_{predict} obtained using the trained deep neural networks, for deep neural networks of type 1, type 2, and type 3, respectively. It can be seen that there is little difference between the gain patterns obtained using the optimal weight vector \vec{ω}ₒₚₜ of the null-space beamforming method and the gain patterns obtained using \vec{ω}_{predict} even as the number of array elements increases, and the similarity of these patterns confirms that the SINR performance is optimally maintained by the beamforming method of the present disclosure.

By comparing FIGS. 4 and 6 of the conventional adaptive beamforming method and FIGS. 5 and 7 of the beamforming method of the present disclosure, respectively, it can be seen that the differences in the SINR performance and antenna gain pattern increase as the number of array elements in the antenna increases in the conventional adaptive beamforming method, whereas this is not the case in the beamforming method of the present disclosure. Accordingly, the higher the number of array elements included in the antenna, the higher the suitability and utilization of the beamforming method of the present disclosure.

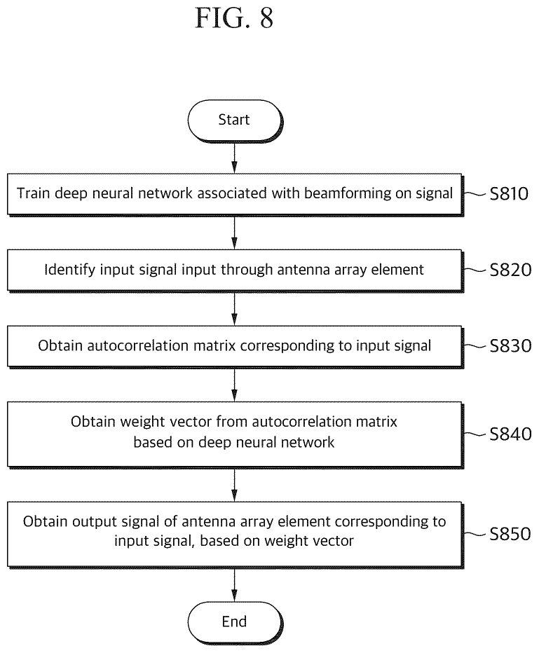

FIG. 8 is a flowchart of how an electronic apparatus performs beamforming according to a representative example embodiment.

In operation S810, the electronic apparatus 100 may train a deep neural network associated with beamforming on a signal. In operation S820, the electronic apparatus 100 may identify an input signal inputted through an antenna array element. In operation S830, the electronic apparatus 100 may obtain an autocorrelation matrix corresponding to the input signal. In operation S840, the electronic apparatus 100 may obtain a weight vector from the autocorrelation matrix based on the deep neural network. In operation S850, the electronic apparatus 100 may obtain, based on the weight vector, an output signal of the antenna array element corresponding to the input signal.

In an example embodiment according to FIG. 8, the electronic apparatus 100 may train the deep neural network. The electronic apparatus 100 may model a training input signal, and may obtain a training autocorrelation matrix corresponding to the modeled training input signal. The electronic apparatus 100 may obtain an input data vector based on the training autocorrelation matrix, and may train the deep neural network to output an output data vector including the training output weight in response to the input of the input data vector. The training of the deep neural network may include feedback based on a loss function defined based on the output data vector and an optimal array element weight vector for the null-space beamforming method.

In an example embodiment according to FIG. 8, the deep neural network may include an input layer for receiving input data, an output layer for outputting output data, and at least one hidden layer located between the input layer and the output layer. Each hidden layer included in the at least one hidden layer may include a fully connected layer and a rectified linear unit (ReLU) layer.

In an example embodiment according to FIG. 8, the electronic apparatus 100 may model the training input signal based on a uniform linear array including isotropic elements when modeling the training input signal.

In an example embodiment according to FIG. 8, the optimal array element weight for the null-space beamforming method may be calculated based on an interference signal space comprising a plurality of steering vectors.

In an example embodiment according to FIG. 8, the electronic apparatus 100 may obtain an upper triangular matrix element vector based on the training autocorrelation matrix to obtain the input data vector, and may obtain a training element vector corresponding to the training autocorrelation matrix based on real and imaginary parts extracted from the upper triangular matrix element vector. The electronic apparatus 100 may normalize the training element vector to obtain the input data vector.

In an example embodiment according to FIG. 8, the output data vector may be obtained based on real and imaginary parts extracted from the training output weight, and the optimal array element weight vector may be obtained based on real and imaginary parts extracted from the optimal array element weight for the null-space beamforming method.

In an example embodiment according to FIG. 8, the electronic apparatus 100 may, in the process of training the deep neural network, train the deep neural network such that an operational value of a loss function is minimized based on a plurality of input data vectors set for training the deep neural network, including the input data vector, and a plurality of output data vectors set for training the deep neural network, including the output data vector.

According to the present disclosure, the electronic apparatus 100 may maintain consistent performance as the number of array elements increases without degradation in SINR performance.

The electronic apparatus according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording media include a magnetic storage medium (e.g., ROM (read-only memory), RAM (random-access memory), floppy disk, hard disk, etc.) and an optical reading medium (e.g., CD-ROM and DVD (Digital Versatile Disc)). The computer-readable recording medium may be distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, Python, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

It will be apparent to those skilled in the art that various modifications and variations can be made in the embodiments without departing from the spirit or scope of the invention. Thus, it is intended that the present invention cover the modifications and variations of this invention provided they come within the scope of the appended claims and their equivalents.

What is claimed is:

1. A method of performing beamforming on a signal by an electronic apparatus, the method comprising:
training a deep neural network associated with beamforming on a signal;
identifying an input signal input through an antenna array element;
obtaining an autocorrelation matrix corresponding to the input signal;
obtaining a weight vector from the autocorrelation matrix based on the deep neural network; and
obtaining an output signal of the antenna array element corresponding to the input signal based on the weight vector.

2. The method of claim 1, wherein training the deep neural network comprises:
modeling a training input signal;
obtaining a training autocorrelation matrix corresponding to the training input signal;
obtaining an input data vector based on the training autocorrelation matrix; and
training the deep neural network to output an output data vector comprising a training output weight in response to an input of the input data vector, and
the training of the deep neural network comprises feedback according to a loss function defined based on an optimal array element weight vector for a null-space beamforming method and the output data vector.

3. The method of claim 2, wherein the deep neural network comprises:
an input layer for receiving input data;
an output layer for outputting output data; and
at least one hidden layer located between the input layer and the output layer, and
each hidden layer included in the at least one hidden layer comprises:
a fully connected layer; and
a rectified linear unit (ReLU) layer.

4. The method of claim 2, wherein modeling the training input signal comprises modeling the training input signal based on a uniform linear array comprising isotropic elements.

5. The method of claim 2, wherein the optimal array element weight vector for the null-space beamforming method is calculated based on an interference signal space comprising a plurality of steering vectors.

6. The method of claim 2, wherein obtaining the input data vector comprises:
obtaining an upper triangular matrix element vector based on the training autocorrelation matrix;
obtaining a training element vector corresponding to the training autocorrelation matrix based on real and imaginary parts extracted from the upper triangular matrix element vector; and
normalizing the training element vector to obtain the input data vector.

7. The method of claim 6, wherein the output data vector is obtained based on real and imaginary parts extracted from the training output weight.

8. The method of claim 2, wherein training the deep neural network comprises:
training the deep neural network to minimize an operational value of the loss function based on a plurality of input data vectors set for the training of the deep neural network including the input data vector and a plurality of output data vectors set for the training of the deep neural network including the output data vector.

9. A non-transitory computer-readable storage medium having a program for executing on a computer a method of performing beamforming by an electronic apparatus recorded thereon, the method comprising:
training a deep neural network associated with beamforming on a signal;
identifying an input signal input through an antenna array element;
obtaining an autocorrelation matrix corresponding to the input signal;
obtaining a weight vector from the autocorrelation matrix based on the deep neural network; and
obtaining an output signal of the antenna array element corresponding to the input signal based on the weight vector.

10. An electronic apparatus for performing beamforming on a signal, the electronic apparatus comprising:
a processor, and
one or more memory for storing one or more instructions, wherein the one or more instructions, when executed, causes the processor to:
train a deep neural network associated with beamforming on a signal;
identify an input signal input through an antenna array element;
obtain an autocorrelation matrix corresponding to the input signal;
obtain a weight vector from the autocorrelation matrix based on the deep neural network; and
obtain an output signal of the antenna array element corresponding to the input signal based on the weight vector.
